(19) United States
(12) Patent Application Publication
(10) Pub. No.: US 2025/0215528 A1
(43) Pub. Date: Jul. 3, 2025

(54) METHOD AND APPARATUS FOR RECOVERING RARE EARTH METALS FROM SCRAP CONTAINING RARE EARTH METAL

(71) Applicants: HYUNDAI MOTOR COMPANY, Seoul (KR); KIA CORPORATION, Seoul (KR); SUNG LIM RARE EARTH METAL, CO., LTD, Daegu (KR)

(72) Inventors: Bo Kyeong Han, Hwaseong-si (KR); Byung Chul Lim, Daegu (KR)

(73) Assignees: HYUNDAI MOTOR COMPANY, Seoul (KR); KIA CORPORATION, Seoul (KR); SUNG LIM RARE EARTH METAL, CO., LTD, Daegu (KR)

(21) Appl. No.: 18/599,443

(22) Filed: Mar. 8, 2024

(30) Foreign Application Priority Data
Jan. 3, 2024 (KR) 10-2024-0000771

(51) Int. Cl. C22B 59/00; C22B 1/02; C22B 3/46; C22B 7/00

(52) U.S. Cl. CPC C22B 59/00; C22B 1/02; C22B 3/46; C22B 7/007

(57) ABSTRACT

A method of recovering rare earth metals from scrap material that contains rare earth metal includes: (a) forming an oxide by subjecting scrap material to oxidation roasting; (b) preparing a first filtrate by acid leaching the result of step (a) and filtering the residue; (c) forming a precipitate by adding an oxidizing agent to the first filtrate and adjusting pH; (d1) preparing a second filtrate by filtering the precipitate formed in step (c); (d2) obtaining a rare earth metal leaching solution by acid leaching the precipitate formed in step (c) at a predetermined pH and filtering the residue to prepare a third filtrate; and (d3) combining the third filtrate with the second filtrate. Accordingly, a rare earth metal recovery rate is 88 wt % or more based on rare earth metals in the scrap material.

### CROSS-REFERENCE TO RELATED APPLICATION

This application claims, under 35 U.S.C. § 119(a), the benefit of priority to Korean Patent Application No. 10-2024-0000771, filed on Jan. 3, 2024, the entire contents of which are incorporated herein by reference.

### BACKGROUND

### (a) Technical Field

The present disclosure relates to a method and an apparatus for recovering rare earth metals from scrap material containing rare earth metal.

### (b) Background Art

In order to recover rare earth metals from waste magnets or scrap including byproducts, sludge, chips, etc. generated during production of magnets, processes of crushing the objects to be recovered and then leaching only the target metal may be performed.

The one-stage recovery process using hydrochloric acid, sulfuric acid, etc., which is a wet recovery process including such leaching, has a low leaching rate when applied to waste magnet powder with a large particle size, scrap, and the like. Such a process is also difficult to use because the leaching rate of iron (Fe), which is a non-rare earth metal, increases.

In a process for recovering rare earth metals from scrap that contains rare earth metal, the design of methods capable of satisfying a high recovery rate, low non-rare earth metal leaching rate, and minimized processing time is desirable.

### SUMMARY OF THE DISCLOSURE

The present disclosure has been made keeping in mind the problems encountered in the related art. An object of the present disclosure is to provide a method of recovering rare earth metals with satisfactorily high purity and high recovery rate from scrap material that contains rare earth metal and materials to be recovered, including waste permanent magnets, waste motors, and byproducts generated during manufacture of rare earth magnets.

Another object of the present disclosure is to provide a method of recovering rare earth metals at a high recovery rate from scrap material that contains rare earth metal, where the method is simpler and has a shorter processing time.

The objects of the present disclosure are not limited to the foregoing. The objects of the present disclosure should be more clearly understood through the following description and are realized by the methods and apparatuses described in the claims and combinations thereof.

In order to accomplish the above objects, an aspect of the present disclosure provides a method of recovering rare earth metals from scrap material that contains rare earth metal. The method includes (a) forming an oxide by subjecting scrap material to oxidation or oxidative roasting. The method also includes (b) preparing a first filtrate by acid leaching the result of step (a) and filtering the residue. The method also incudes (c) forming a precipitate by adding an oxidizing agent to the first filtrate and adjusting pH. The method also includes (d1) preparing a second filtrate by filtering the precipitate formed in step (c). The method also includes (d2) obtaining a rare earth metal leaching solution by acid leaching the precipitate formed in step (c) at a predetermined pH and filtering the residue to prepare a third filtrate, which is then combined with the second filtrate. According to the above method, a rare earth metal recovery rate may be 88 wt % or more based on rare earth metals in the scrap material.

Another aspect of the present disclosure provides an apparatus for recovering rare earth metals from scrap material that contains rare earth metal. The apparatus includes a heat treatment unit configured to subject the scrap material to oxidation or oxidative roasting. The apparatus also includes a first treatment unit configured to acid leach the result obtained from the heat treatment unit, to add an oxidizing agent to a first filtrate obtained by filtering the residue, and to adjust pH to form a precipitate. The apparatus also includes a storage unit configured to store a second filtrate obtained by filtering the precipitate. The apparatus also includes a second treatment unit configured to acid leach the precipitate at a predetermined pH and transfer a third filtrate obtained by filtering the residue to the storage unit.

### BRIEF DESCRIPTION OF THE DRAWINGS

The above and other features of the present disclosure are described in detail referring to certain embodiments thereof illustrated in the accompanying drawings, which are given hereinbelow by way of illustration only, and thus are not limitative of the present disclosure, and wherein:

FIG. 1 is a flowchart schematically showing a process of recovering rare earth metals from scrap material that contains rare earth metal according to an aspect of the present disclosure;

FIG. 2 schematically shows a process of recovering rare earth metals from scrap that contains rare earth metal according to another aspect of the present disclosure; and

FIG. 3 schematically shows an apparatus for recovering rare earth metals from scrap that contains rare earth metal according to an aspect of the present disclosure.

### DETAILED DESCRIPTION

The above and other objects, features, and advantages of the present disclosure should be more clearly understood from the following embodiments taken in conjunction with the accompanying drawings. However, the present disclosure is not limited to the embodiments disclosed herein and the embodiments may be modified into different forms. These embodiments are provided to thoroughly explain the technical concept of the disclosure and to sufficiently transfer the spirit of the present disclosure to those having ordinary skill in the art.

Throughout the drawings, the same reference numerals refer to the same or like elements. For the sake of clarity of the present disclosure, the dimensions of structures may be depicted as being larger than the actual sizes thereof. It should be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, etc., and variations thereof, when used in this specification, specify the presence of stated features, integers, steps, operations, elements, components, or combinations thereof. Such terms do not preclude the presence or addition of one or more other features, integers, steps, operations, elements, components, or combinations thereof. Also, it should be understood that, when an element such as a layer, film, area, or sheet is referred to as being “on” another element, the element may be directly on the other element, or intervening elements may be present therebetween. Similarly, when an element such as a layer, film, area, or sheet is referred to as being “under” another element, the element may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

When performing a one-stage wet process to recover rare earth metals from waste from drive motors used in eco-friendly vehicles and byproducts generated during production of rare earth magnets, it may be difficult to obtain a high leaching rate due to a difference in average particle size. When crushing is carried out at a finer particle size, processing cost may become very high, which is undesirable.

As used herein, the nomenclature “scrap material” and the term “scrap” may refer to objects that are to be or are being scrapped or discarded. The nomenclature may also refer to material that is to be or is being scrapped or discarded as well as to scrap, waste material, or byproducts from the manufacture of objects or other materials. In a method of preparing an aqueous rare earth chloride solution through a hydrochloric acid treatment process after immersing scrap material contains rare earth metal in sodium hydroxide, the leaching rate of rare earth metals may be about 70%. When the pre-roasting treatment temperature is low, it may be difficult to selectively leach rare earths.

When attempting to recover rare earth metal from scrap material through two-stage acid leaching, a long leaching time may be required, scrap has to be additionally fed in the middle process, and filtration time may also be prolonged. These issues can lower productivity.

In order to solve such problems, the following methods and apparatuses have been developed for recovering rare earth metals and are is described in detail below.

Method of Recovering Rare Earth Metals from Scrap Material that Contains Rare Earth Metal

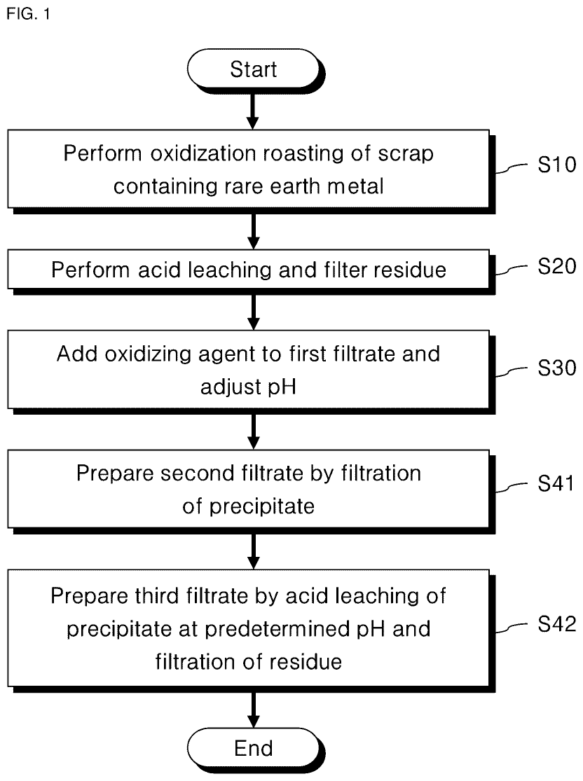

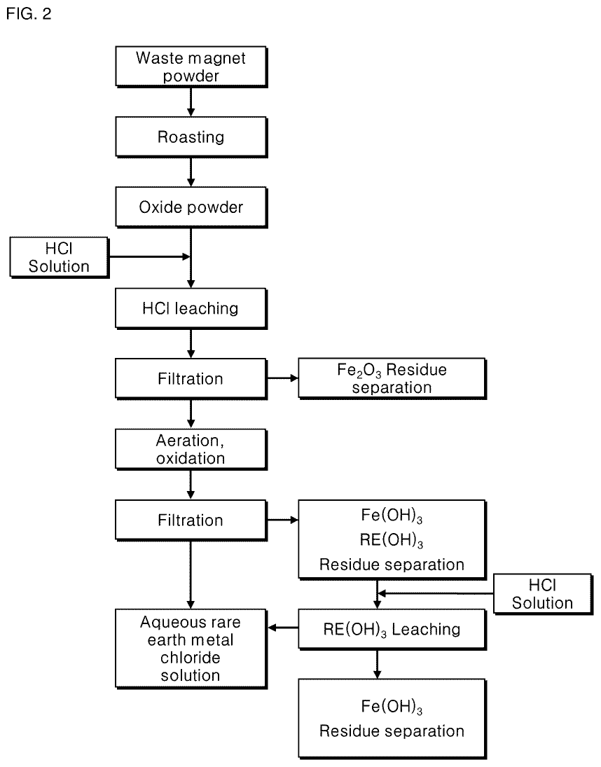

Referring to FIGS. 1 and 2, a method of recovering rare earth metals from scrap material that contains rare earth metal according to an aspect of the present disclosure is illustrated. The method includes:
(a) forming an oxide by subjecting the scrap material that contains rare earth metal to oxidation or oxidative roasting (step S10);
(b) preparing a first filtrate by acid leaching the result of step (a) and filtering the residue (step S20);
(c) forming a precipitate by adding an oxidizing agent to the first filtrate prepared in step (b) and adjusting pH (step S30);
(d1) preparing a second filtrate by filtering the precipitate formed in step (c) (step S41);
(d2) obtaining a rare earth metal leaching solution by acid leaching the precipitate formed in step (c) at a predetermined pH and filtering the residue to prepare a third filtrate, which is then combined with the second filtrate (step S42).

Here, the rare earth metal recovery rate based on rare earth metals in the scrap may be 88 wt % or more. The recovery rate may be 90 wt % to 99 wt %.

The scrap may include one object or material selected from a group consisting of or comprising rare earth magnet production byproducts, waste rare earth magnet motors, neodymium (Nd), praseodymium (Pr), terbium (Tb), dysprosium (Dy), or any combination thereof. For example, the scrap may include iron (Fe) and rare earth metals or may include NdFe-based magnet production byproducts, chips, sludge or waste NdFe-based magnets, waste motors of electric vehicles, or the like.

The scrap may have a Dv50 particle size in a range of 50 μm to 300 μm, or 50 μm to 200 μm.

Dv50 particle size refers to a particle size at which the cumulative volume corresponds to 50% of the particle volume-ratio distribution curve.

Step (a) (S10) may further include grinding the scrap so that the Dv particle size is 75 μm or less, depending on the Dv50 particle size of the scrap. The grinding process may be performed so that the Dv particle size of the scrap is 50 μm or less, or even 25 μm or less. This grinding treatment may contribute to improving the leaching rate in the subsequent step.

The grinding may be performed using a ball mill, a roll mill, a jaw crusher, or the like.

The oxidation or oxidative roasting temperature in step (a) (step S10) may be in a range of 550° C. to 730° C., or in a range of 600° C. to 700° C. Within such a temperature range, rare earth metals and non-rare earth metals contained in the scrap may be oxidized and easily leached in the subsequent step. The non-rare earth metal may mean a metal other than a rare earth metal. Examples of the rare earth metal may include neodymium (Nd), praseodymium (Pr), terbium (Tb), dysprosium (Dy), and the like. Examples of the non-rare earth metal may include iron, cobalt (Co), manganese (Mn), magnesium (Mg), chromium (Cr), and the like.

The oxidation or oxidative roasting in step (a) (step S10) may be performed for a time period between 1 hour to 8 hours, or between 2 hours to 5 hours.

When the scrap in step (a) (step S10) includes neodymium and iron, it may include Nd₂O₃, NdFeO₂, Fe₂O₃, (where Nd=neodymium, O=oxygen, Fe=Iron) or the like. through oxidation roasting.

The acid leaching in step (b) (step S20) may be carried out using an acid solution. The acid solution may include one selected from a group comprising or consisting of hydrochloric acid, sulfuric acid, nitric acid, or any combination thereof, and for example, may be carried out using hydrochloric acid.

When the acid leaching in step (b) (step S20) is performed with a hydrochloric acid solution, the molar concentration thereof may be in a range of 0.7 M to 2 M, or in a range of 1 M to 1.8 M. If the molar concentration thereof is less than 0.7 M, the leaching rate may be low, making it difficult to attain a desired rare earth metal recovery rate. If the molar concentration thereof is greater than 2.0 M, the leaching rate of non-rare earth metals may also increase, which may not be effective in improving purity.

The acid leaching in step (b) (step S20) may be carried out so that the amount of the scrap is 5 wt % to 15 wt % based on 100 wt % of the total leaching solution. This may be the so-called pulp density. If the amount of the scrap is less than 5 wt %, the leaching rate of non-rare earth metals may increase. If the amount of the scrap is greater than 15 wt %, the leaching rate may be low, making it difficult to attain a desired rare earth metal recovery rate.

The acid leaching temperature in step (b) (step S20) may be in a range of 45° C. to 85° C., or may be in a range of 55° C. to 70° C.

The acid leaching time in step (b) (step S20) may be in a range between 1 hour to 5 hours, or between 2 hours to 4 hours.

When the leaching in step (b) (step S20) is performed within the above temperature and time ranges, the leaching rate of rare earth metals may be attained as desired and an improvement in the leaching rate of non-rare earth metals may be minimized.

The leaching rate of rare earth metals after step (b) (step S20) based on the scrap before step (b) (step S20) may be 90 wt % or more, or 92 wt % or more, and 99 wt % or less.

The leaching rate of non-rare earth metals after step (b) (step S20) based on the scrap before step (b) (step S20) may be less than 90 wt %, or 75 wt % or less, and 20 wt % or more.

The oxidation agent in step (c) (step S30) may include one selected from a group consisting of or comprising hydrogen peroxide, sodium hydroxide, ozone, or any combination thereof, and may include, for example, hydrogen peroxide.

The pH of step (c) (step S30) may be in a range of 3.2 to 4.2, or in a range of 3.5 to 4.

Through step (c) (step S30), rare earth metals and some non-rare earth metals in the first filtrate leached in step (b) may be precipitated in the form of hydroxide. Examples thereof may include RE(OH)ₓ, Fe(OH)₃, or the like. Here, RE is a rare earth metal, and x is any integer from 2 to 4.

Step (c) (step S30) may further include aerating the first filtrate, which may be performed through an aeration process or the like.

Step (d1) (step S41) may include storing the second filtrate obtained by filtering the precipitate formed in step (c) (step S30) in a separate storage unit.

The acid leaching in step (d2) (step S42) may be carried out using an acid solution. The acid solution may include one selected from a group consisting of or comprising hydrochloric acid, sulfuric acid, nitric acid, or any combination thereof, and for example, may be carried out using a hydrochloric acid solution.

When step (d2) (step S42) is performed using a hydrochloric acid solution, the pH of the leaching solution may be in a range of 3 to 3.8, or in a range of 3.2 to 3.5. This pH range may contribute to selective leaching of the target rare earth metal and easy filtration and separation of the residual non-rare earth metal precipitate.

Step (d2) (step S42) may be performed for a time period between 1 hour to 4 hours.

The method of recovering rare earth metals from scrap material that contains rare earth metal may further include adding an acid solution to the rare earth metal leaching solution and adjusting pH.

Based on the total amount of metals in the rare earth metal leaching solution, the amount of non-rare earth metals may be 5 wt % or less, or 4.5 wt/o or less.

Based on 100 wt % of rare earth metals in the scrap, the amount of rare earth metals in the rare earth metal leaching solution may be 88 wt % or more, 90 wt % or more, or 92 wt % or more, or 99 wt % or less.

As described, the method of recovering rare earth metals from scrap material that contains rare earth metal according to an aspect of the present disclosure is capable of obtaining a rare earth metal leaching solution with high purity and of recovering rare earth metals at a high recovery rate through a simplified process for a short period of time. The method ultimately exhibits superior economic efficiency and productivity.

In the method of recovering rare earth metals from scrap material that contains rare earth metal according to an aspect of the present disclosure, the starting material may be changed to a recovery target, and the recovery target may include rare earth metals and non-rare earth metals.

Apparatus for Recovering Rare Earth Metals from Scrap that Contains Rare Earth Metal

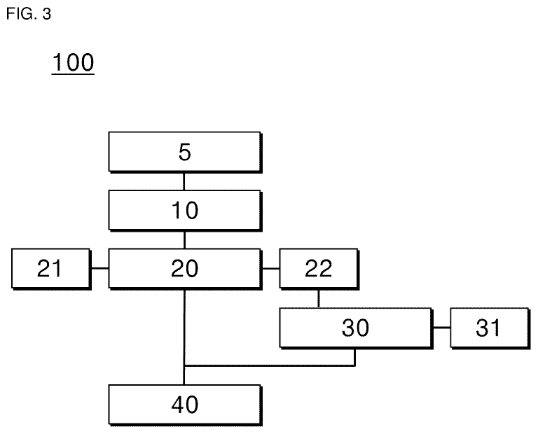

Referring to FIGS. 2 and 3, an apparatus 100 for recovering rare earth metals from scrap material that contains rare earth metal according to an aspect of the present disclosure includes
a heat treatment unit 10 configured to subject scrap that contains rare earth metal to oxidation or oxidative roasting. The apparatus 100 also includes a first treatment unit 20 configured to acid leach the result obtained from the heat treatment unit 10, to add an oxidizing agent to a first filtrate obtained by filtering the residue, and to adjust pH to form a precipitate. The apparatus 100 also includes a storage unit 40 configured to store a second filtrate obtained by filtering the precipitate. The apparatus 100 also includes a second treatment unit 30 configured to acid leach the precipitate at a predetermined pH and transfer a third filtrate obtained by filtering the residue to the storage unit 40.

In order to transfer the oxidation roasting result of the heat treatment unit 10 to the first treatment unit 20, the heat treatment unit 10 and the first treatment unit 20 may be connected to and communicate with each other through a separate channel or the like and may also include a separate transport technique or mechanism.

The first treatment unit 20 may further include a first filter 21 configured to filter and separate the residue formed by acid leaching the result obtained from the heat treatment unit 10.

The first treatment unit 20 may further include a second filter 22 configured to filter and separate the precipitate formed when adding an oxidizing agent and adjusting pH.

The first treatment unit 20 may further include an aerator (not shown) configured to perform aeration when adding an oxidizing agent and adjusting pH.

In order to transfer the precipitate from the first treatment unit 20 to the second treatment unit 30, the first treatment unit 20 or the second filter 22 and the second treatment unit 30 may be connected to or communicate with each other through a separate channel or the like and may also include a separate transport technique or mechanism.

The second treatment unit 30 may include a third filter 31 configured to filter and separate a non-rare earth metal precipitate, which is the residue after acid leaching at a predetermined pH.

The apparatus 100 for recovering rare earth metals from scrap that contains rare earth metal may further include a grinding unit 5 disposed upstream from the heat treatment unit 10 and configured to grind the scrap so that the Dv50 particle size of the scrap is 75 μm or less. In order to transfer the ground result from the grinding unit 5 to the heat treatment unit 10, the grinding unit 5 and the heat treatment unit 10 may be connected to and communicate with each other through a separate channel or the like and may also include a separate transport technique or mechanism.

The storage unit 40 may be configured such that the second filtrate obtained by filtering the precipitate of the first treatment unit 20 and the third filtrate prepared from the second treatment unit 30 may be combined and stored.

In some cases, additional acid solution may be added, and pH adjustment may be performed in the storage unit 40.

The steps, processes, and conditions related to grinding, heat treatment, initial acid leaching, oxidation roasting, the oxidizing agent, pH adjustment, aeration, late acid leaching at a predetermined pH, filtration of non-rare earth metal precipitate or residue in the grinding unit 5, the heat treatment unit 10, the first treatment unit 20, and the second treatment unit 30 are substantially the same as those described in the recovery method above, and a redundant description thereof has been omitted.

A better understanding of the present disclosure may be obtained through the following examples and comparative examples. However, these examples are not construed as limiting the technical spirit of the present disclosure.

### Example 1

In step (a), waste magnet scrap containing iron (Fe), praseodymium (Pr), neodymium (Nd), terbium (Tb), and dysprosium (Dy) metals recovered from a waste electric vehicle motor and having a Dv50 particle size of about 150 μm was ground to have a Dv50 particle size of about 25 μm. The ground result was subjected to oxidation or oxidative roasting at 650° C. for 4 hours.

In step (b), the oxidizing roasting result was acid leached for 2 hours under conditions of a hydrochloric acid concentration of 1 M, a pulp density of 10 wt %, and a temperature of 65° C., and the Fe₂O₃ residue was filtered and separated to prepare a first filtrate.

In step (c), hydrogen peroxide was added to the first filtrate, pH was maintained at 3.5, and aeration was performed to form a precipitate.

In step (d1), a second filtrate was prepared by filtering the precipitate formed in step (c).

In step (d2), the precipitate formed in step (c) was leached with hydrochloric acid at a pH of 3.3 to selectively leach a rare earth metal precipitate. The residual non-rare earth metal precipitate was filtered to prepare a third filtrate, which was then combined with the second filtrate, yielding a rare earth metal leaching solution.

### Example 2

A rare earth metal leaching solution was obtained under the same conditions as in Example 1, with the exception that the concentration of hydrochloric acid in step (b) was changed to 2 M.

### Example 3

A rare earth metal leaching solution was obtained under the same conditions as in Example 1, with the exception that the grinding in step (a) was omitted and the hydrochloric acid concentration in step (b) was changed to 2 M.

### Comparative Example 1

A rare earth metal leaching solution was obtained under the same conditions as in Example 1, with the exception that the concentration of hydrochloric acid in step (b) was changed to 0.5 M.

### Comparative Example 2

A rare earth metal leaching solution was obtained under the same conditions as in Example 1, with the exception that the oxidizing roasting temperature in step (a) was changed to 750° C.

### Comparative Example 3

A rare earth metal leaching solution was obtained under the same conditions as in Example 1, with the exception that the oxidizing roasting temperature in step (a) was changed to 850° C.

### Comparative Example 4

A rare earth metal leaching solution was obtained under the same conditions as in Example 1, with the exception that the grinding in step (a) was omitted, the oxidizing roasting temperature was changed to 750° C., and the concentration of hydrochloric acid in step (b) was changed to 2 M.

### Comparative Example 5

A rare earth metal leaching solution was obtained under the same conditions as in Example 1, with the exception that the grinding in step (a) was omitted, the oxidizing roasting temperature was changed to 850° C., and the concentration of hydrochloric acid in step (b) was changed to 2 M.

The conditions of Examples and Comparative Examples are shown in Table 1 below.

TABLE 1

| | (a) Dv50 | | (b) Oxidizing | (b) Molar | |
|---|---|---|---|---|---|
| | particle | | roasting | concentration | |
| Classification | size of scrap | | temperature | of hydrochloric acid | |
| Example 1 | 25 | μm | 650° C. | 1 | M |
| Example 2 | 25 | μm | 650° C. | 2 | M |
| Example 3 | 150 | μm | 650° C. | 2 | M |
| Comparative | 25 | μm | 650° C. | 0.5 | M |
| Example 1 | | | | | |
| Comparative | 25 | μm | 750° C. | 1 | M |
| Example 2 | | | | | |
| Comparative | 25 | μm | 850° C. | 1 | M |
| Example 3 | | | | | |
| Comparative | 150 | μm | 750° C. | 2 | M |
| Example 4 | | | | | |
| Comparative | 150 | μm | 850° C. | 2 | M |
| Example 5 | | | | | |

### Test Example—Analysis of Leaching Rate for Each Metal in Leaching Solution in Step (b)

Inductively Couple Plasma Optical Emission Spectroscopy (ICP-OES) was performed on the amount of each metal leached in the leaching solution after acid leaching in step (b) in Examples and Comparative Examples above using the iCAP 7000 Series from Thermo Scientific. The results thereof are shown in Tables 2 and 3 below.

TABLE 2

| | | | | | | Rare | |
|---|---|---|---|---|---|---|---|
| | | | | | | earth | |
| | Fe | Pr | Nd | Tb | Dy | sum | Total |
| Example 1 | 9.86 | 1.02 | 3.32 | 0.04 | 0.19 | 4.57 | 14.43 |
| Scrap (g) | | | | | | | |
| Example 1 | 6.86 | 0.98 | 3.09 | 0.035 | 0.171 | 4.28 | 11.14 |
| Leached amount | | | | | | | |
| (g) in step (b) | | | | | | | |
| Example 1 | 69.6 | 96.1 | 93.1 | 87.5 | 90 | 93.6 | 77.2 |
| Leaching rate | | | | | | | |
| (%) in step (b) | | | | | | | |
| Example 2 | 9.86 | 1.02 | 3.32 | 0.04 | 0.19 | 4.57 | 14.43 |
| Scrap (g) | | | | | | | |
| Example 2 | 8.81 | 0.95 | 3.15 | 0.036 | 0.181 | 4.32 | 13.13 |
| Leached amount | | | | | | | |
| (g) in step (b) | | | | | | | |
| Example 2 | 89.4 | 93.1 | 94.9 | 90 | 95.3 | 94.5 | 91 |
| Leaching rate | | | | | | | |
| (%) in step (b) | | | | | | | |
| Example 3 | 8.95 | 0.97 | 3.43 | 0.1 | 0.18 | 4.68 | 13.63 |
| Scrap (g) | | | | | | | |
| Example 3 | 6.21 | 0.9 | 3.05 | 0.08 | 0.16 | 4.22 | 10.41 |
| Leached amount | | | | | | | |
| (g) in step (b) | | | | | | | |
| Example 3 | 69.4 | 92.8 | 88.9 | 80 | 88.9 | 90.2 | 76.4 |
| Leaching rate | | | | | | | |
| (%) in step (b) | | | | | | | |

TABLE 3

| | | | | | | Rare | |
|---|---|---|---|---|---|---|---|
| | | | | | | earth | |
| | Fe | Pr | Nd | Tb | Dy | sum | Total |
| Comparative | 9.86 | 1.02 | 3.32 | 0.04 | 0.19 | 4.57 | 14.43 |
| Example 1 | | | | | | | |
| Scrap (g) | | | | | | | |
| Comparative | 5.73 | 0.72 | 2.74 | 0.021 | 0.142 | 3.63 | 9.35 |
| Example 1 | | | | | | | |
| Leached amount | | | | | | | |
| (g) in step (b) | | | | | | | |
| Comparative | 58.1 | 70.6 | 82.5 | 52.5 | 74.7 | 79.3 | 64.8 |
| Example 1 | | | | | | | |
| Leaching rate | | | | | | | |
| (%) in step (b) | | | | | | | |
| Comparative | 9.86 | 1.02 | 3.32 | 0.04 | 0.19 | 4.57 | 14.43 |
| Example 2 | | | | | | | |
| Scrap (g) | | | | | | | |
| Comparative | 4.76 | 0.74 | 2.72 | 0.034 | 0.149 | 3.64 | 8.4 |
| Example 2 | | | | | | | |
| Leached amount | | | | | | | |
| (g) in step (b) | | | | | | | |
| Comparative | 48.3 | 72.5 | 81.9 | 85 | 78.4 | 79.6 | 58.2 |
| Example 2 | | | | | | | |
| Leaching rate | | | | | | | |
| (%) in step (b) | | | | | | | |
| Comparative | 9.86 | 1.02 | 3.32 | 0.04 | 0.19 | 4.57 | 14.43 |
| Example 3 | | | | | | | |
| Scrap (g) | | | | | | | |
| Comparative | 4.68 | 0.77 | 2.84 | 0.027 | 0.15 | 3.79 | 8.47 |
| Example 3 | | | | | | | |
| Leached amount | | | | | | | |
| (g) in step (b) | | | | | | | |
| Comparative | 47.5 | 75.5 | 85.5 | 67.5 | 78.9 | 82.9 | 58.7 |
| Example 3 | | | | | | | |
| Leaching rate | | | | | | | |
| (%) in step (b) | | | | | | | |
| Comparative | 5.91 | 0.89 | 3.2 | 0.1 | 0.14 | 4.33 | 10.24 |
| Example 4 | | | | | | | |
| Scrap (g) | | | | | | | |
| Comparative | 3.01 | 0.8 | 2.6 | 0.08 | 0.12 | 3.6 | 6.61 |
| Example 4 | | | | | | | |
| Leached amount | | | | | | | |
| (g) in step (b) | | | | | | | |
| Comparative | 50.9 | 89.9 | 81.3 | 80 | 85.7 | 83.1 | 64.6 |
| Example 4 | | | | | | | |
| Leaching rate | | | | | | | |
| (%) in step (b) | | | | | | | |
| Comparative | 4.49 | 0.73 | 2.73 | 0.08 | 0.13 | 3.67 | 8.16 |
| Example 5 | | | | | | | |
| Scrap (g) | | | | | | | |
| Comparative | 1.07 | 0.6 | 2.4 | 0.07 | 0.11 | 3.28 | 4.25 |
| Example 5 | | | | | | | |
| Leached amount | | | | | | | |
| (g) in step (b) | | | | | | | |
| Comparative | 23.8 | 82.2 | 87.9 | 87.5 | 84.6 | 89.4 | 52.1 |
| Example 5 | | | | | | | |
| Leaching rate | | | | | | | |
| (%) in step (b) | | | | | | | |

Referring to Tables 2 and 3, Examples satisfying (a) the appropriate oxidation roasting temperature and (b) the molar concentration of hydrochloric acid exhibited the high leaching rate of rare earth metals during acid leaching in step (b). In particular, in Example 1, even when the scrap was ground, the leaching rate of non-rare earth metals was suppressed from being excessively high.

### Test Example—Two-Stage Acid Leaching and Leaching Rate Analysis of Examples

A rare earth metal leaching solution was obtained by changing the scrap in Example 1 to another waste magnet scrap (Example 1′). In addition, as shown in Table 4 below, a leaching solution was obtained by subjecting waste magnet scrap to two-stage acid leaching (Comparative Example 6). The metal leaching rate of each solution in some steps of Example 1′ and Comparative Example 6 was analyzed through ICP-OES. The results thereof are shown in Tables 4 and 5 below.

In Comparative Example 6, the first-stage acid leaching was carried out in the pH range of 1-2 with a hydrochloric acid solution. The second-stage acid leaching was performed in the pH range of 3.5-4 with a hydrochloric acid solution after adding a certain amount of scrap to the filtrate obtained by filtering the residue from the first-stage leaching.

TABLE 4

| | | | | | | Rare |
|---|---|---|---|---|---|---|
| | | | | | | earth |
| Classification | Fe | Pr | Nd | Tb | Dy | sum |
| First-stage | 10.3 | 1.03 | 3.34 | 0.03 | 0.189 | 4.59 |
| Scrap (g) | | | | | | |
| First-stage | 6.31 | 1 | 3.3 | 0.029 | 0.176 | 4.51 |
| Leached amount (g) | | | | | | |
| First-stage | 61.3 | 97.1 | 98.8 | 96.7 | 93.1 | 98.2 |
| Leaching rate (%) | | | | | | |
| Second-stage | 13.76 | 2.51 | 9.16 | 0.3 | 0.49 | 12.47 |
| First-stage filtrate + | | | | | | |
| scrap (g) | | | | | | |
| Second-stage | 0.25 | 1.83 | 6.44 | 0.21 | 0.25 | 8.73 |
| Leached amount (g) | | | | | | |
| Second-stage | 1.8 | 72.9 | 70.4 | 71.7 | 49.9 | 70.1 |
| Leaching rate (%) | | | | | | |

TABLE 5

| | | | | | | Rare |
|---|---|---|---|---|---|---|
| | | | | | | earth |
| Classification | Fe | Pr | Nd | Tb | Dy | sum |
| (b) Scrap (g) | 10.01 | 1.04 | 3.48 | 0.032 | 0.165 | 4.72 |
| (b) Leached amount (g) | 6.68 | 1.02 | 3.41 | 0.031 | 0.159 | 4.62 |
| (b) Leaching rate (%) | 66.7 | 98.1 | 98 | 96.9 | 96.4 | 97.9 |
| (d1) Second filtrate (g) | 0.13 | 0.6 | 2.58 | 0.021 | 0.125 | 3.33 |
| (d1) Leaching rate (%) | 1.3 | 58.3 | 77.2 | 70 | 66.1 | 72.5 |
| of second filtrate | | | | | | |
| (d2) Third filtrate (g) | 0.06 | 0.39 | 0.65 | 0.008 | 0.048 | 1.1 |
| (d2) Leaching rate (%) | 0.6 | 37.9 | 19.5 | 26.7 | 25.4 | 23.9 |
| of third filtrate | | | | | | |
| Final leaching solution | 0.19 | 0.99 | 3.23 | 0.029 | 0.173 | 4.42 |
| (g) (second + third | | | | | | |
| filtrate) | | | | | | |
| Leaching rate (%) of | 1.8 | 96.1 | 96.7 | 96.7 | 91.5 | 96.4 |
| final leaching solution | | | | | | |

Referring to Tables 4 and 5, in Comparative Example 6 in which two-stage hydrochloric acid leaching was applied, re-leaching was necessary due to high rare earth content in the residue after the second-stage leaching. Additional scrap was added in the second stage, making it difficult to determine the exact recovery rate and causing high risk of loss of rare earth metals.

In Example 1′, the iron content percentage (leaching rate) in the final leaching solution based on iron content in the raw scrap was about 1.8 wt % and a high rare earth metal recovery rate resulted. Moreover, fast process speed and process simplification were achieved, and high productivity was exhibited.

According to the present disclosure, rare earth metals can be recovered with satisfying high purity and high recovery rate from scrap material that contains rare earth metal. Scrap materials to be recovered, including permanent magnets, waste motors, and byproducts generated during manufacture of rare earth magnets, and the amounts of non-rare earth metals, iron, and the like can be reduced.

In addition, according to the present disclosure, a method of recovering rare earth metals at a very high rate from scrap that contains rare earth metal can be simpler and can achieve a shorter processing time. Thus, the size of a leaching-related device, a leaching tank, and the like can be reduced.

The effects of the present disclosure are not limited to the above-mentioned effects. It should be understood that the effects of the present disclosure include all effects that can be inferred from the description of the present disclosure.

Although specific embodiments of the present disclosure have been described, those having ordinary skill in the art should appreciate that the disclosed embodiments may be embodied in other specific forms without changing the technical spirit or essential features thereof. Thus, the embodiments described above should be understood to be non-limiting and illustrative in every way.

What is claimed is:

1. A method of recovering rare earth metals from a scrap material that contains rare earth metal, the method comprising the steps of:
(a) forming an oxide by subjecting the scrap material to oxidation roasting;
(b) preparing a first filtrate by acid leaching a result of step (a) and filtering a residue;
(c) forming a precipitate by adding an oxidizing agent to the first filtrate and adjusting pH;
(d1) preparing a second filtrate by filtering the precipitate formed in step (c); and
(d2) obtaining a rare earth metal leaching solution by acid leaching the precipitate formed in step (c) at a predetermined pH and filtering a residue to prepare a third filtrate, which is then combined with the second filtrate,
wherein a rare earth metal recovery rate is 88 wt % or more based on rare earth metals in the scrap material.

2. The method of claim 1, wherein the scrap material comprises one selected from a group consisting of rare earth magnet production byproducts, waste rare earth magnets, waste motors, neodymium, praseodymium, terbium, dysprosium, and combination thereof.

3. The method of claim 1, wherein step (a) further comprises grinding the scrap material so that a Dv50 particle size of the scrap material is 75 μm or less.

4. The method of claim 1, wherein the oxidation roasting in step (a) is performed at a temperature in a range of 550° C. to 730° C.

5. The method of claim 1, wherein the acid leaching in step (b) is performed using an acid solution comprising one selected from a group consisting of hydrochloric acid, sulfuric acid, nitric acid, and combination thereof.

6. The method of claim 5, wherein the acid solution in step (b) comprises hydrochloric acid, with a molar concentration in a range of 0.7 M to 2 M.

7. The method of claim 1, wherein the acid leaching in step (b) is performed so that an amount of the scrap material is 5 wt % to 15 wt % based on a total acid leaching solution.

8. The method of claim 1, wherein the acid leaching in step (b) is performed at a temperature in a range of 45° C. to 85° C.

9. The method of claim 1, wherein the acid leaching in step (b) is performed for a period of time in a range of 1 hour to 5 hours.

10. The method of claim 1, wherein the oxidizing agent in step (c) comprises one selected from a group consisting of hydrogen peroxide, sodium hydroxide, ozone, and combination thereof.

11. The method of claim 1, wherein the pH in step (c) is in a range of 3.2 to 4.2.

12. The method of claim 1, wherein step (c) further comprises aerating the first filtrate.

13. The method of claim 1, wherein the acid leaching in step (d2) is performed using an acid solution comprising one selected from a group consisting of hydrochloric acid, sulfuric acid, nitric acid, and combination thereof.

14. The method of claim 13, wherein the acid solution in step (d2) comprises hydrochloric acid and the predetermined pH is 3 to 3.8.

15. An apparatus for recovering rare earth metals from a scrap material that contains rare earth metal, the apparatus comprising:
a heat treatment unit configured to subject the scrap material to oxidation roasting;
a first treatment unit configured to acid leach a result obtained from the heat treatment unit, to add an oxidizing agent to a first filtrate obtained by filtering a residue, and to adjust pH to form a precipitate;
a storage unit configured to store a second filtrate obtained by filtering the precipitate; and
a second treatment unit configured to acid leach the precipitate at a predetermined pH and transfer a third filtrate obtained by filtering a residue to the storage unit.
